(19) United States
(12) Patent Application Publication
(10) Pub. No.: US 2012/0216909 A1
(43) Pub. Date: Aug. 30, 2012

(54) Dosing Adapter for Use with Oral Syringe

(76) Inventor: Abner Levy, (US)

(21) Appl. No.: 13/363,328

(22) Filed: Jan. 31, 2012

Related U.S. Application Data
(63) Continuation-in-part of application No. 12/917,476, filed on Nov. 1, 2010.

(51) Int. Cl. A61J 1/20; B65B 3/04

(52) U.S. Cl. 141/2; 604/77; 604/403

(57) ABSTRACT

An oral syringe of the type having a syringe barrel terminating in a syringe neck with a blunt orificed end is combined with a medication bottle provided with a self resealing elastomeric closure designed for admitting the syringe neck into the bottle while maintaining a sufficient liquid tight seal against the syringe neck to allow a dose of medication to be drawn from the bottle in an inverted condition of the bottle without significant leakage, the closure resealing itself upon withdrawal of the syringe neck.

This application is a continuation-in-part of pending utility patent application Ser. No. 12/917,476 filed Nov. 1, 2010.

### BACKGROUND OF THE INVENTION

1. Field of the Invention

This invention generally pertains to methods and devices useful for the administration and delivery of liquid oral medications and more particularly concerns a dosing adapter having a self resealing closure for medication bottles containing liquid medication drawn and administered by oral syringes.

2. State of the Prior Art

The administration of liquid medications such as cough and cold medicines, whether over the counter or prescription medication, to young children and infants requires careful control over dosage. In the case of adults the dosage of such medications is often measured by tea or table-spoonfuls. The spoons may vary in size to a considerable degree, and they may be filled to different levels, resulting in substantial variations in the administered dose. Adults, because of their larger body mass, are unlikely to suffer adverse effects from such variations. However, small children, having much smaller body mass, have often suffered adverse consequences and in fact result in thousands of children being hospitalized each year. Similar problems occur when unsupervised children gain access to and take such medicines, which are often colored and flavored to appeal to children's tastes, and thus may receive an overdose of the medicine. The aforementioned difficulties are compounded when the liquid medications are concentrated and intended for administration with a dropper. A parent may think little of giving a child an extra drop or two, thinking it is a harmless amount, but in fact this too may have undesirable and harmful outcomes in the case of small children.

More recently this problem has been addressed through the use of oral syringes which more accurately measure and dispense small volumes of liquid medication in a consistent manner. Oral syringes differ from conventional hypodermic type syringes in that the neck extending from the end of the syringe barrel is sized such that standard hypodermic needles cannot be mated to it. Instead, the oral syringe is used to deliver a stream of liquid medication to the oral cavity of young patients, who are often uncooperative.

The liquid medication is drawn by immersing the open end of the neck of the syringe in the contents of the medication bottle and pulling the syringe plunger from the barrel in the conventional manner. The neck of the medication bottle typically does not admit the syringe barrel into the bottle, so that the liquid contents must be brought within reach of the syringe end by tilting the bottle. However, as the contents of the bottle are consumed and depleted, the liquid level drops and it becomes necessary to incline the bottle to an increasing degree so as to bring the liquid within reach of the short neck of the oral syringe. This can be difficult to accomplish without spilling some of the contents. This process has been somewhat facilitated through the use of a plug fitted into the neck of the medication bottle and having a plug opening of reduced diameter relative to the diameter of the bottle neck. The plug opening admits the syringe neck into the bottle neck but also provides an interior rim which helps contain the liquid contents while the dose is drawn into the syringe. Also, the barrel end may be pressed against the plug to further help contain the liquid during this operation.

Nonetheless, the use of oral syringes with liquid medications remains inconvenient and dependent to an undesirable degree upon the manual dexterity of the user.

### SUMMARY OF THE INVENTION

According to the present invention, a liquid oral medication bottle is provided with a self resealing elastomeric closure normally sealing the bottle and adapted to admit the syringe neck into the bottle while maintaining a substantially liquid tight seal between the elastomeric closure and the syringe neck. The neck of the oral syringe has an orificed blunt end which is inserted through the elastomeric closure into the bottle. The bottle is tilted or inverted such that the orificed blunt end is immersed in the liquid medication contained in the bottle, and a dose of the medication is drawn into the syringe barrel. The syringe neck is withdrawn from the bottle to allow self resealing of the elastomeric closure.

In one embodiment of the invention the elastomeric closure is initially unbroken and the method further comprises the step of urging the orificed blunt end of the syringe neck against the elastomeric closure with sufficient force for rupturing the closure and passing the neck's orificed end therethrough and into the bottle.

The elastomeric closure preferably has a septum of elastomeric material, the septum having a generally depressed dished portion including an area of minimum thickness. The dished portion increases in thickness radially from the minimum thickness to a much thicker elastomeric material encompassing the area of minimum thickness, the depressed portion and the area of minimum thickness being shaped and configured to elastically distend for passing the blunt orificed end of the syringe neck through a tear in the area of minimum thickness. The septum self recloses by returning opposite edges of the tear to a substantially contiguous closed condition after withdrawal of the syringe neck from the septum.

In one embodiment of the invention the elastomeric closure is pre-cut with a slit which extends through the thickness of the septum, and the septum is sized, dimensioned and configured for returning the slit to a substantially closed condition after withdrawal of the syringe from the slit.

The invention also contemplates a dosing adapter kit suitable for retail sale for use with conventional medication bottles such as may be provided with prescription medications by a pharmacy. The dosing adapter kit in a presently preferred form includes one or more plugs provided with self-resealing elastomeric closures according to this invention and an oral syringe having a syringe neck sized for penetration through the septum of the self-resealing plug. A person receiving the filled medication bottle may purchase the dosing adapter kit at the same time, and install a suitably sized plug into the neck of the medication bottle in lieu of or in combination with the conventional cap provided with the bottle. Thereafter the oral syringe supplied with the adapter kit may be used as previously explained for drawing doses of the liquid medication from the bottle through the self resealing closure in the dosing adapter plug.

The one or more adapter plugs and the oral syringe of the adapter kit may be packaged in a blister card package for convenient retail display and sale. These and other improvements, features and advantages of the present invention will be more clearly understood by reference to the following detailed description of the preferred embodiment taken in conjunction with the accompanying drawings.

### BRIEF DESCRIPTION OF THE DRAWINGS

FIG. 1 shows a prior art plug of the type fitted in liquid medication bottles for use in conjunction with an oral syringe;

FIG. 2 is a cross sectional view of the plug of FIG. 1 taken along line 2-2 in FIG. 1;

FIG. 3 is a top side perspective view of the improved plug with the self resealing elastomeric closure according to the present invention;

FIG. 4 is a cross sectional view taken along line 4-4 in FIG. 3;

FIG. 4a is an enlarged cross section as in FIG. 4;

FIG. 5 is a top side perspective view of a typical medication bottle fitted with the plug of FIGS. 3 and 4;

FIG. 6 is a cross section taken along line 6-6 in FIG. 5;

FIG. 7 illustrates how the neck of the oral syringe is inserted through the elastomeric closure of the inverted medication bottle of FIGS. 5 and 6;

FIG. 8 shows how a dose of liquid medication is drawn into the oral syringe from the inverted medication bottle;

FIG. 9 is a cross section taken along line 9-9 showing the sealing engagement of the elastomeric seal about the exterior surface of the syringe neck;

FIG. 10 is a view taken as in FIG. 9 showing the self resealing of the elastomeric closure to a substantially liquid tight condition upon withdrawal of the oral syringe, and illustrates a tear left by perforation of an initially unbroken septum, or alternately, a pre-existing cut made through the septum;

FIG. 11 illustrates typical delivery of the medication dose by the oral syringe to the oral cavity of a child; and

FIG. 12 is a front view of a blister package including two different sized dosing adapter plugs and one oral syringe for retail sale as a kit.

### DETAILED DESCRIPTION OF THE PREFERRED EMBODIMENTS

With reference to the accompanying drawings in which like numerals reference like elements, FIGS. 1 and 2 show a prior art plug of the type fitted in the neck of liquid oral medication bottles in order to facilitate the drawing of the liquid medication into an oral syringe.

The prior art plug generally indicated by numeral 10 has a plug top 12 in which is defined a circular depression 14 bounded at a lower end by an interior annular flange 16 which encompasses a center hole 18 through the plug top. Plug 10 also has a cylindrical side wall 22 open at a lower end 22a and from which extend four axially spaced radial ribs 24. The center hole 18 provides a reduced aperture when plug 10 is pressed into the neck of a medication bottle and interior flange 16 provides an annular containment dam which helps reduce the likelihood of spillage when the medication bottle is tilted or inverted onto the oral syringe. Nonetheless, substantial dexterity of the user on the part of the user is needed to avoid spillage of the liquid medication.

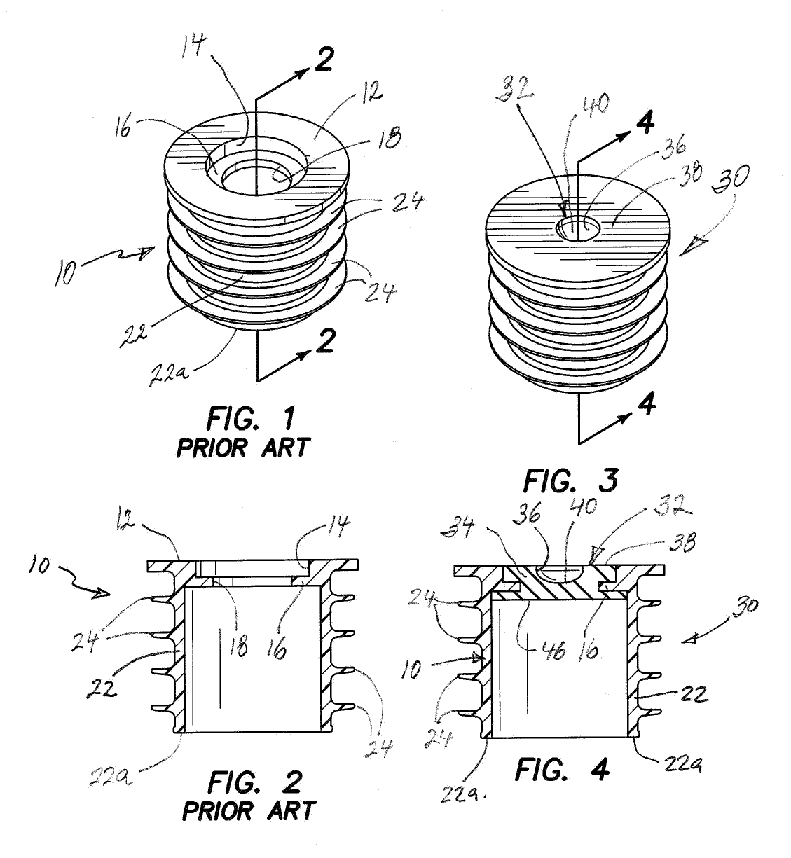

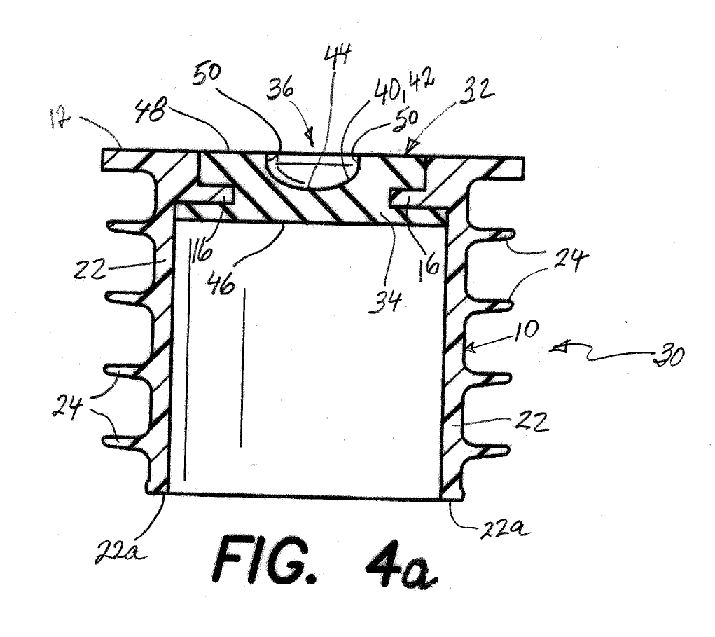

FIGS. 3 and 4 show an improved plug 30 according to the present invention. In plug 30 a self resealing elastomeric closure 32 closes the center hole 18 of the prior art plug 10. The prior art plug structure (hereafter referred to as shell 10) is used in the plug 30 of this invention as a supporting shell for the self resealing closure 32. The self resealing elastomeric closure 32 includes a one piece closure body 34 supported in an interference fit above and below the inner flange 16 of shell 10, such that the closure body 34 is permanently locked to the shell 10.

In a presently preferred method of manufacture plug 30 is manufactured in a two step process, in which the shell 10 is molded first and closure 32 is then molded onto the shell 10. This two step process permits different materials to be used for the two components, each suited to its function. The closure body is preferably molded of a relatively soft thermoplastic elastomeric material, for example, GLS2711 sold by GLS Thermoplastic Elastomers based in McHenry, Ill., a business unit of PolyOne Corporation of Avon Lake, Ohio. The plug shell 10 is preferably made of a harder, stiffer thermoplastic material such as polypropylene, a presently preferred material being a 50-50% blend of polypropylene and Synprene thermoplastic elastomer available from PolyOne Corporation.

The closure body 34 is generally disk shaped with a central depression 36 including a dished septum 40 in the top surface 38 of the closure body 34. As best seen in FIG. 4a, the septum 40 has a generally depressed dished portion 42 including an area of minimum thickness 44 as measured between the septum bottom and the underside or interior surface 46 of the closure body 34. The dished portion 42 of septum 40 increases in thickness radially from the minimum thickness 44 to a much thicker elastomeric material 48 encompassing the area of minimum thickness.

It has been found advantageous to provide a greater minimum thickness of elastomer in the self resealing closure 32 intended for perforation by the neck of an oral syringe than the smaller minimum thickness preferred in previous filings and earlier disclosed embodiments of the perforable self-resealing elastomeric closure of this invention. For example, in a plug 30 of nominal 20 mm diameter the overall thickness of closure body 34 may be approximately 3 mm, the diameter of central depression 36 at the top surface 38 may be 4.80 mm, the depth of the central depression 36 may be 1.5 mm deep and the minimum thickness at the center of the closure body 34 may be 1.6 mm thick. For a 24 mm diameter plug 30 the thickness of closure body 34 may be approximately 4.25 mm, the diameter of central depression 36 at the top surface 38 may be 5.5 mm, the depth of the central depression 36 may be 2.00 mm deep and the minimum thickness at the center of the closure body 34 may be 2.25 mm thick. In general, the minimum thickness 44 at the bottom of the dished portion 42 in plug 30 may be approximately equal to the depth of the central depression 36.

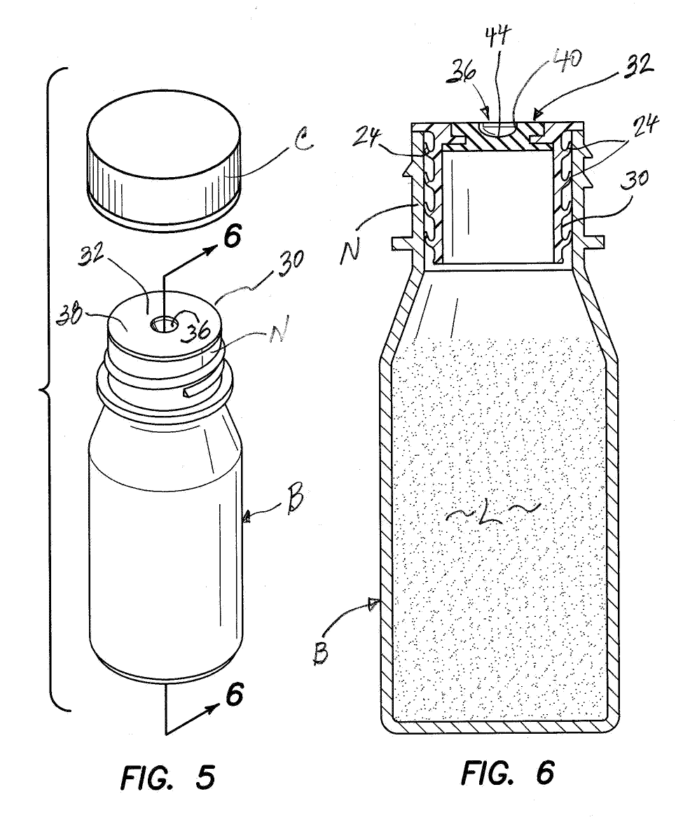

FIGS. 5 and 6 illustrate a typical medication bottle B fitted with the self resealing elastomeric plug 30 of FIGS. 3 and 4. As shown in FIG. 6, when the plug 30 is press-fitted into the bottle neck N, the radial ribs 18 are flexed upwardly from their normal radial condition and the inherent resilience of the elastomeric rib material presses the ribs 18 against interior of the cylindrical bottle neck in a friction fit which both retains the plug 30 in the bottle neck N and also provides a liquid tight seal for containing the liquid contents L from leaking between the plug and the bottle neck. The bottle neck N also has an exterior thread T onto which is screwed a removable twist-on bottle cap C. In an initial condition of elastomeric closure 32 the septum 40 is unbroken, i.e., forms a continuous closed partition across the bottle neck N, as seen in the cross section of FIG. 6.

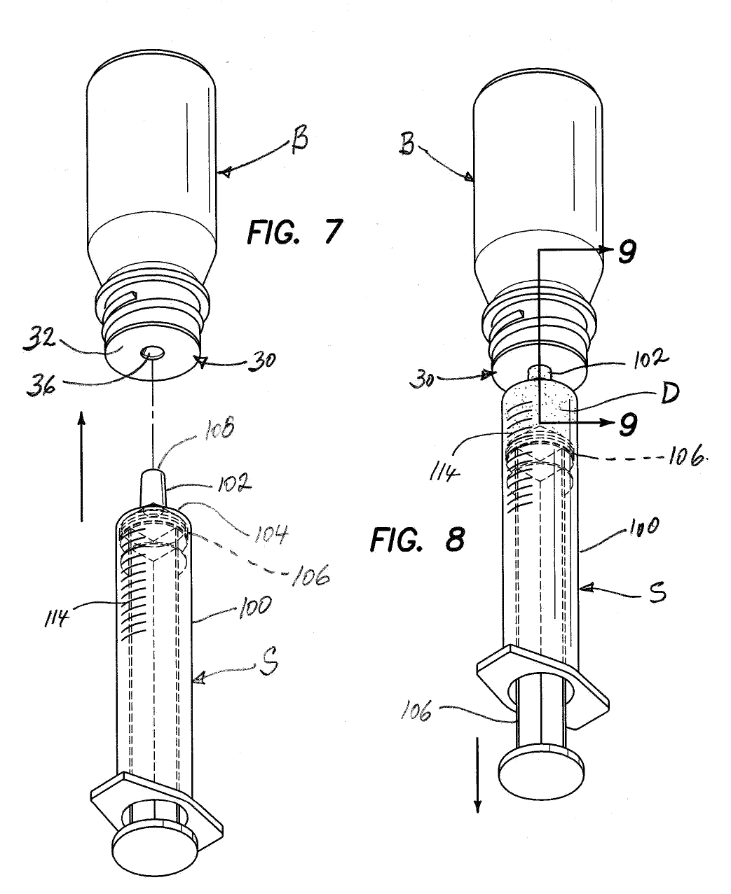

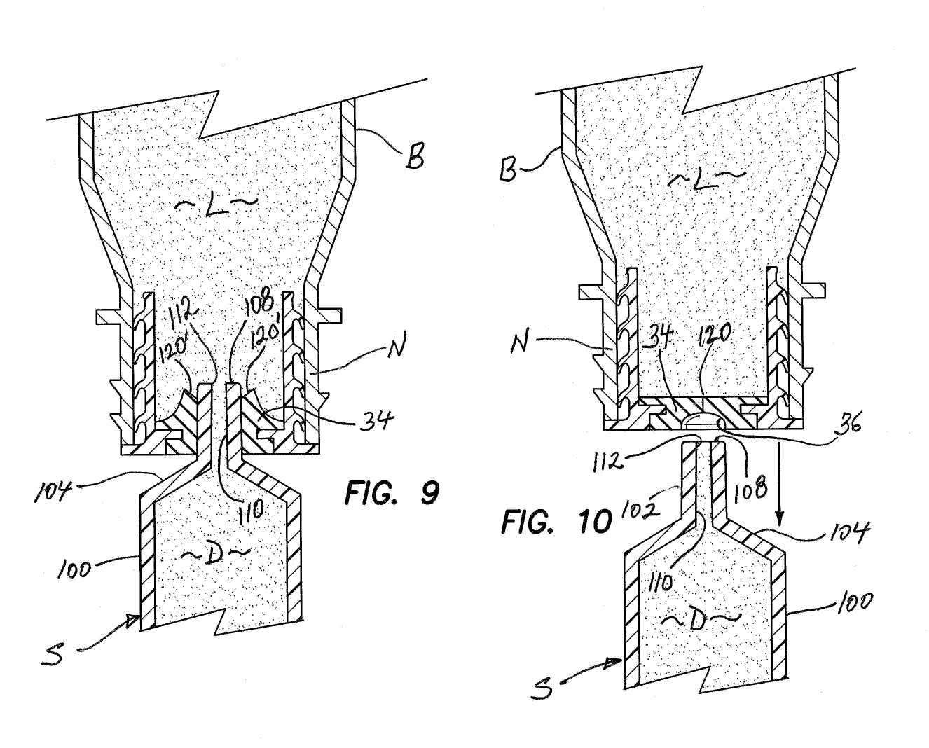

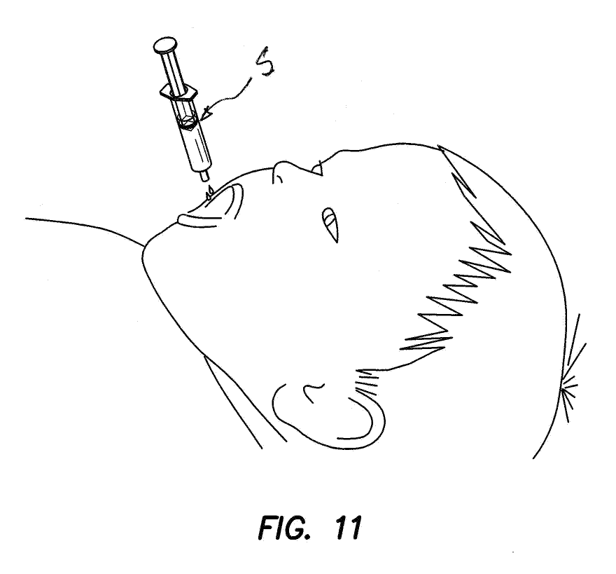

FIGS. 7 and 8 illustrate how a dose of liquid medication is drawn with a typical oral syringe S from medication bottle B provided with the plug 30 of this invention. Oral syringe S may be a commercially available syringe having a syringe barrel 100 with a syringe neck 102 at a proximal end of the barrel 100 and a syringe plunger 106 slidable within barrel 100. Syringe neck 102 extends from an end wall 104 of the syringe barrel. The syringe neck 102 is a cylindrical or tapering stub terminating in a generally blunt end 108. A bore 110 through syringe neck 102 opens in an orifice 112 in the blunt end 108 and communicates with the interior of the syringe barrel 100, as best seen in FIGS. 9 and 10.

The depressed dished portion 42 and the area of minimum thickness 44 are shaped and configured to rupture and elastically distend for under the urging of the blunt orificed end 108 of the syringe neck 102 and passing the orificed end 108 and a portion of neck 102 through a tear 120 created in the area of minimum thickness 44 of the septum 40, a condition depicted in FIG. 9. The dished portion 42 and the area of minimum thickness 44 are self reclosing by returning opposite edges 120′ of the tear to a substantially contiguous closed condition after withdrawal of the syringe neck 102 from the torn septum, as shown in FIG. 10.

Preferably, the shape and diameter of the upper portion 50 of the central depression 36 is sized to closely receive the syringe neck 102, The upper portion 50 helps guide the neck of the syringe and to hold it in general alignment with the center of the area of minimum thickness 44 of dished septum 40 as the syringe neck 102 is advanced into the depression 36 and urged against the depressed portion 42 to rupture or tear the area of minimum thickness and through septum 40, thereby to place the orifice 112 on the blunt end 108 at the end of the syringe neck into fluidic communication with the interior of the medicine bottle N, a condition seen in FIGS. 8 and 9.

As shown in FIG. 8, the medication bottle with the fluidically coupled oral syringe may be held inverted or upside down so that the liquid contents L in the bottle N overlie the orifice 112 of the syringe neck. In this position, the plunger 106 of the oral syringe S may be pulled from the syringe barrel 100, thereby to draw a dose D of liquid medication L into the syringe barrel. The prescribed dosage is measured by aligning the plunger bottom with a corresponding marker 114 on the syringe barrel.

In the fluidically coupled condition of FIG. 8, the perforated elastomeric closure 32 is distended to admit passage of the syringe neck 102 and because of its inherent elasticity forms a tight seal about the exterior surface of the syringe neck, as in FIG. 9. A close fit between syringe neck 102 and upper portion 50 of depression 36 further assists in preventing leakage. Consequently, the liquid L is contained in the bottle B and does not leak onto the underlying syringe S.

Once the desired dosage D has been drawn, the oral syringe S is withdrawn from the bottle B, whereupon the elastomeric closure 32 is free to self reseal to a substantially liquid tight condition, as indicated in FIG. 10.

The improved plug 30 with the self resealing closure 32 of this invention provides a number of advantages over the prior art plug of FIGS. 1 and 2.

Firstly, the normally closed condition of the elastomeric septum, both before and after perforation with a syringe S, prevents contamination of the contents L with dust or any pollutants present in the immediate environment even while the bottle cap C is removed.

Secondly, the normally closed condition of the elastomeric closure makes the medication bottle doubly childproof, i.e., even if the twist-on cap C is forgotten, or even if it is removed by the child, the child is unable to drink from the bottle contents, which remain secure even if the bottle is turned upside down or tilted into the child's mouth.

Thirdly, the bottle is leak proof with or without the twist-on cap C as a result of the normally closed, substantially liquid tight elastomeric closure 32.

Fourth, the bottle can be upended onto the oral syringe S with little risk of leakage or spillage of the liquid medication L. This is an improvement over the prior art where continuous care had to be observed while drawing the liquid medication into the oral syringe to prevent spillage through the open hole of the prior art plug.

The plug 30 can be made in various diameters and dimensions to fit medication bottles or other containers having container or bottle necks N of different dimensions. The upper diameter of the central cavity 36 in each case is guided by the neck diameter of the oral syringe S to be used with that combination of plug 30 and container B. For example, oral syringes in 5 ml, 10 ml and 20 ml capacities are in general use and have syringe necks 102 of varying sizes, typically 3 to 4 mm in diameter. In each case, the diameter of upper portion 50 of the center cavity of the plug is sized accordingly to closely receive the diameter of the syringe neck.

It should be understood that in alternate embodiments of the invention the central cavity 36 may be inverted on the closure body 34 so that the cavity opens into the interior of the medicine bottle B and the dished septum faces the bottle interior.

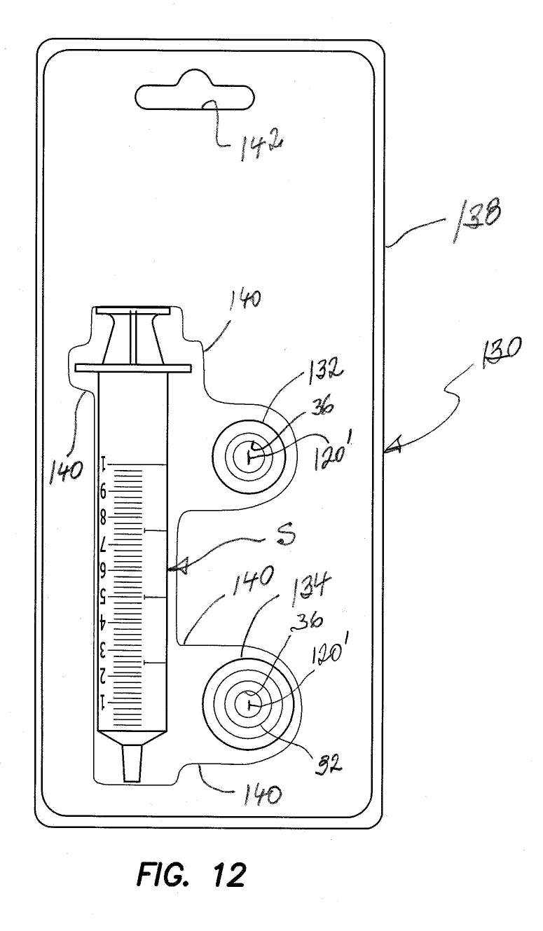

In another embodiment of this invention the dosing plug 30 has a self-resealing elastomeric closure which is pre-cut, punched or perforated with a small slit or cut similar to tear 120 in FIG. 10 extending generally diametrically across the central area of minimum thickness of the closure. Preferably the pre-existing cut extends through the full thickness of the elastomeric septum, although it could also extend partially in an initial condition od the plug, so that the cut is completed through the full thickness of the closure upon insertion of the oral syringe S. This dosing plug embodiment with pre-cut slit is also illustrated in FIG. 12 where dosing adapter plugs 132, 134 are shown with pre-cut slits 120′ generally centered in the central depression 36 of self-resealing elastomeric closure 32 of each plug. The size of the cut 120′ is sufficient to admit the orificed end 108 of the syringe neck 102 through the elastomeric closure 34 by allowing the closure's elastomer to stretch and encompass the syringe neck 102 while maintaining a good seal by the elastomer against the circumference of the syringe neck, so as to allow the bottle B to be inverted over the syringe S as in FIG. 8 without significant leakage of the bottle contents. For example, the length of slit 120′ may be slightly shorter than the diameter of the orificed blunt end 108 of the syringe neck 102. The minimum thickness 44 of dished portion 42 of septum 40 has a thickness and shape so as to provide sufficient resilient force of the elastomer to keep the slit 120′ normally closed, while allowing the syringe neck 102 to be admitted through the pre-existing slit 120′ without excessive effort. In general, the choice of elastomer and the shape and dimensions of the septum 40 and dished portion 42 are selected so as to return the closure to a substantially liquid tight closed condition following each dosing operation with the oral syringe S, i.e. after insertion and withdrawal of the syringe neck 102 through the pre-cut elastomeric septum.

While different embodiments of the elastomeric septum 40 have been described, this invention is not limited to a particular self resealing closure 32, so long as the closure is self resealing to a substantially liquid tight condition following penetration and withdrawal of the neck of an oral syringe S. For example, as described above, the self-resealing elastomeric closure may be initially unbroken and rupturable by application of the syringe neck, or may be pre-cut or pierced with one or more slits or cuts in any way conducive to self-resealing action.

The pre-cut dosing adapter plugs of this invention include a pre-punched form or a pre-slit form. A pre-punched plug can be made by piercing the elastomeric septum through or near its center with a sharpened tapered tool similar to a punch or awl. The punch perforation will return to a closed condition after the piercing or punching tool is withdrawn. Such a pre-punched perforation will result in the septum elastomer closely surrounding and conforming to the circular cross section of the syringe neck when the neck is pushed into and through this perforation in the septum, and will tend to form a substantially air tight seal around the syringe neck. In many applications such a seal is acceptable or desirable.

In a pre-slit form of the dosing adapter plug, a longitudinal slit is cut through the septum, for example across the full diameter of the dished depression in the septum, using an implement such as a cutting blade. The pre-cut slit is also held in substantially liquid tight closed condition by the resilient elastomeric material of the septum following the pre-cutting operation. When the syringe neck of circular cross section is pushed through the pre-cut slit the septum conforms only partially to the syringe neck and assumes an elongated shape such an eye, with the opposite ends or corners of the distended slit remaining open. The end apertures serve to relieve pressure in the bottle or container and allow equalization of internal pressure with ambient atmospheric. This configuration is useful where the liquid being dispensed with the oral syringe is relatively viscous, as the bottle B may be inverted over the syringe S, as previously explained and shown in FIGS. 7 and 8, without leakage of the viscous liquid through the small open ends of the pre-cut slit. For this purpose the slit is pre-cut to a length somewhat greater than the diameter of the syringe neck to be employed.

FIG. 12 shows a preferred embodiment of a dosing adapter kit generally designated by the numeral 130. The kit 130 includes two self resealing dosing adapter plugs 132, 134 of different sizes, selected to fit into the necks of larger and smaller medication bottles used for dispensing liquid medications, e.g. in pharmacies, for example a bottle B as seen in FIGS. 5-10. Each dosing adapter plug 132, 134 is similar to plug 30 described above and illustrated in earlier figures. In particular, each plug 132, 134 may have a self-resealing septum which can be penetrated by the neck of an appropriately sized oral syringe S. The self resealing septum may be either pre-cut with a slit or may have an initially unbroken septum perforable by the blunt tip at the end of the neck of the oral syringe. The kit 130 also includes an oral syringe S which may be a conventional oral syringe chosen to have a syringe neck 102 sized for penetrating the self-resealing septum in either of plugs 132, 134.

The kit 130 provides the necessary elements for converting medication bottles provided with conventional threaded caps to a safer, more precise and convenient use with oral syringes as has been previously described above. The kit 130 in the embodiment of FIG. 12 is packaged in a blister retail package consisting of a cardboard card 138 on one side of which is affixed a vacuum formed clear plastic blister 140 shaped to contain and protect the components of the kit, plugs 132, 134 and oral syringe S, against contamination and damage. A hanger slot 142 is cut near the top edge of card 138 for hanging the blister pack on a conventional retail rack in a store or other retail vending location. The components can be extracted for use by tearing either or both the card 138 and plastic blister 140. The manufacture of the blister package may be conventional and promotional graphics and user information may be printed on one or both sides of card 138. While a presently preferred form of packaging the components of kit 130 has been described, it should be understood that the invention is not limited to any particular packaging of these components. Further the kit may include different numbers and sizes of dosing adapter plugs, and one or more oral syringes for use with the plugs.

While it is contemplated that this invention is primarily for use in dosing of oral medications with an oral syringe, many other applications and uses of the disclosed invention will become apparent to persons in different fields. For example the combination of self-resealing dosing plugs and oral syringe may be used for dispensing consistent amounts of fluids such as epoxy which need to be kept in closed containers. Applications may also include dosing of medications for topical application or for veterinary use.

While particular embodiments of the invention have been described and illustrated for purposes of clarity and explanation it should be understood that still other changes, modifications and substitutions will be apparent to those having only ordinary skill in the art without departing from the scope of the present invention as defined in the following claims.

What is claimed is:

1. A method for drawing a dose of liquid oral medication from a bottle into an oral syringe comprising the steps of:
providing an oral syringe of the type having a syringe barrel terminating in a syringe neck with an orificed blunt end;
providing a medication bottle with a self resealing elastomeric closure normally sealing said bottle and adapted to admit said syringe neck into said bottle while maintaining a substantially liquid tight seal between said closure and said neck; said closure being configured, sized and adapted to return to a substantially liquid tight condition following withdrawal of said syringe neck from said closure;
inserting said blunt orificed end of said syringe neck through said elastomeric closure into said bottle;
inverting said bottle and said syringe such that said orificed end is immersed in liquid medication contained in said bottle;
drawing a dose of said medication into said syringe barrel; and
withdrawing said syringe neck to allow self resealing of said elastomeric closure.

2. The method of claim 1 wherein said closure is initially unbroken and further comprising the step of urging said orificed end against said closure with sufficient force for breaking said closure and passing said orificed end therethrough and into said bottle.

3. The method of claim 1 wherein said closure is initially pre-cut with a slit through said closure for admitting the orificed blunt neck of an oral syringe through said slit in substantially liquid tight sealing engagement of said elastomeric closure with said neck.

4. In combination, an oral syringe having a syringe barrel terminating in a syringe neck with a blunt orificed end and a medication bottle having a self resealing elastomeric closure, said closure being sized, dimensioned and configured for admitting said orificed end through said closure and into said bottle while maintaining a substantially liquid tight seal with said syringe neck and for returning to a substantially liquid tight condition following withdrawal of said orificed end from said closure.

5. The combination of claim 3 wherein said closure is initially unbroken and is rupturable under urging of said orificed end thereagainst for breaking said closure and passing said orificed end through said closure and into said bottle.

6. The method of claim 3 wherein said closure is initially pre-cut with a slit through said closure for admitting the orificed blunt neck of an oral syringe through said slit in substantially liquid tight sealing engagement of said elastomeric closure with said neck.

7. The combination of claim 3 said closure having a septum of elastomeric material, said septum having a generally depressed dished portion including an area of minimum thickness, said dished portion increasing in thickness radially from a minimum thickness to a much thicker elastomeric material encompassing said area of minimum thickness, said depressed portion and said area of minimum thickness being shaped and configured to elastically distend for passing said blunt orificed end of said syringe neck through a pre-existing cut in said area of minimum thickness, said septum self reclosing by returning opposite edges of said pre-existing cut to a substantially contiguous closed condition after withdrawal of said syringe neck from said septum.

8. In a plug for installation in the neck of a medication bottle, said plug having a shell adapted to make retentive sealing engagement with said neck and having a central hole through said shell of reduced diameter relative to said bottle neck, the improvement comprising a self resealing elastomeric closure normally sealing said bottle and adapted to rupture to the blunt ended orificed neck of an oral syringe into said bottle while maintaining a substantially liquid tight seal between said closure and said neck, said elastomeric closure being adapted to self reseal to a substantially liquid tight condition following withdrawal of said neck from said closure.

9. In a plug for installation in the neck of a medication bottle, said plug having a shell adapted to make retentive sealing engagement with said neck and having a central hole through said shell of reduced diameter relative to said bottle neck, the improvement comprising a self resealing elastomeric closure normally sealing said bottle and a cut in said closure adapted to admit the blunt ended orificed neck of an oral syringe into said bottle while maintaining a substantially liquid tight seal between said closure and said syringe neck, said elastomeric closure being adapted to self reseal said cut to a substantially liquid tight condition following withdrawal of said neck from said closure.

10. The improvement of claim 9 said closure having a septum of elastomeric material, said septum having a generally depressed dished portion including an area of minimum thickness, said dished portion increasing in thickness radially from a minimum thickness to a much thicker elastomeric material encompassing said area of minimum thickness, said depressed portion and said area of minimum thickness being shaped and configured to admit said blunt orificed end of said syringe neck through a pre-existing cut or through a tear in said area of minimum thickness, said septum self reclosing by returning opposite edges of said pre-existing cut or said tear to a substantially contiguous closed condition after withdrawal of said syringe neck from said septum.

11. A kit of parts comprising at least one oral syringe having a syringe neck with a blunt orificend end and at least one dosing adapter plug for installation in the neck of a medication bottle, each said dosing adapter plug having a self resealing elastomeric closure, said closure being sized, dimensioned and configured for admitting said orificed end through said closure and into said bottle while maintaining a substantially liquid tight seal with said syringe neck and for returning to a substantially liquid tight condition following withdrawal of said orificed end from said closure.
